(19) United States
(12) Patent Application Publication
(10) Pub. No.: US 2014/0227546 A1
(43) Pub. Date: Aug. 14, 2014

(54) QUENCHED AND PARTITIONED HIGH-CARBON STEEL WIRE

(71) Applicant: NV BEKAERT SA, Zwevegem (BE)

(72) Inventors: Christophe Mesplont, Croix (FR); Walther Van Raemdonck, Zwevegem (BE)

(73) Assignee: NV BEKAERT SA, Zwevegem (BE)

(21) Appl. No.: 14/345,828

(22) PCT Filed: Sep. 19, 2012
(86) PCT No.: PCT/EP2012/068383

§ 371 Date: Mar. 19, 2014

(30) Foreign Application Priority Data
Sep. 20, 2011 (EP) 11181984.3

(51) Int. Cl. C21D 8/06; F16F 7/00; F16F 1/02; F16L 11/02; D07B 1/06

(52) U.S. Cl. CPC C21D 8/065; F16L 11/02; D07B 1/068; F16F 1/021; F16F 7/00; D07B 2201/2009
USPC 428/544; 138/118; 57/243; 148/333; 148/320; 148/595; 267/182; 267/136

(57) ABSTRACT

A high-carbon steel wire has as steel composition: a carbon content ranging from 0.40 weight percent to 0.85 weight percent, a silicon content ranging from 1.0 weight percent to 2.0 weight percent, a manganese content ranging from 0.40 weight percent to 1.0 weight percent, and a chromium content ranging from 0.0 weight percent to 1.0 weight percent. The remainder is iron. This steel wire has as metallurgical structure a volume percentage of retained austenite ranging from 4 percent to 20 percent, while the remainder is tempered primary martensite and untempered secondary martensite. The steel wire is obtained by partitioning after quenching.

### TECHNICAL FIELD

The present invention relates to a high-carbon steel wire, to a process for manufacturing a high-carbon steel wire and to various uses or applications of such a high-carbon steel wire as spring wire, rope wire, wire in flexible pipe and wire in impact absorption applications.

### BACKGROUND ART

WO2011/004913 discloses a steel wire for a high-strength spring. The steel wire has following composition: carbon between 0.67% and 0.75%, silicon between 2.0% and 2.5%, manganese between 0.5% and 1.2%, chromium between 0.8% and 1.3%, vanadium between 0.03% and 0.20%, molybdenum between 0.05% and 0.25%, tungsten between 0.05% and 0.30% with a particular relationship between manganese and vanadium and between molybdenum and tungsten. All percentages are percentages by weight. The metallographic structure of this steel wire comprises between 6% and 15% of retained austenite with a remainder of martensite.

This steel wire is manufactured by first austenitizing the steel wire above Ac₃ temperature followed by quenching the austenitized steel wire and cooling down to room temperature. The relative high amount of alloying elements lowers the temperature at which the transformation from austenite to martensite starts. This low start temperature is the cause of an incomplete martensite transformation resulting in a percentage of retained austenite. The resulting wire has not only a high strength but also a high level of ductility.

The relative high amount of alloying elements makes the steel wire of WO2011/004913 more expensive. Applying the same process as in WO2011/004913 to a plain carbon composition, i.e. a composition where the alloying elements are limited to less than 0.20% will not result in significant amounts of retained austenite in the final product, since the transformation of austenite to martensite starts earlier at a higher temperature.

Applying partitioning after quenching, results in retaining austenite.

However, this process has not yet been applied to high-carbon steel wires with a diameter ranging from 1.0 mm to 6.0 mm and with a plain carbon steel composition.

WO2004/022794 discloses the general process of quenching and partitioning. A steel sheet or steel bar is first brought to above austenitizing temperature, is subsequently quenched below the Mₛ temperature followed by partitioning above the Mₛ temperature, where Mₛ is the temperature where martensite transformation starts. The final steel product retains a certain volume of austenite. The steel composition and the particular process conditions mentioned in WO2004/022794 are, however, not suitable for high-carbon steel wires.

U.S. Pat. No. 5,904,787 disclose a quenched and oil-tempered wire for springs, wherein the retained austenite content is limited to 1 vol % to 5 vol % and the size and number of carbides is controlled by means of carbide forming elements (V, Mo, W, Nb). A microstructure containing more than 5vol % retained austenite is mentioned to be not suitable for spring application because the resistance to permanent set will decrease due to martensite formation.

JP3162550 describes an oil tempered steel wire with improved strength, ductility and fatigue resistance. In order to produce the microstructure containing 5 to 20 vol % of retained austenite by means of microalloying elements Mo and V and by quenching in oil and tempering.

WO2009/082107 also discloses the process of austenitizing, quenching and partitioning applied to a steel wire rod. The steel wire rod is to be used for bearing steel. The process conditions mentioned in WO2009/082107, and particularly the ten minutes long time needed for partitioning, makes this not economical for high-carbon steel wires with a diameter between 1.0 mm and 6.0 mm.

### DISCLOSURE OF INVENTION

It is an object of the present invention to provide a high-carbon steel wire with limited amount of alloying elements and with a significant volume percentage of retained austenite.

It is another object of the present invention to provide suitable process parameters to manufacture a high-carbon steel wire with a significant volume of percentage of retained austenite.

The present invention describes a steel wire having very high strength and ductility and exceptional cold deformation properties thanks to the transformation induced plasticity effect, and a method to produce such a steel wire in a continuous process using an absolutely available chemical composition without expensive microalloying elements such as Mo, W, V or Nb.

According to a first aspect of the present invention, there is provided a high-carbon steel wire with following steel composition:
a carbon content ranging from 0.40 weight percent to 0.85 weight percent, e.g. between 0.45% and 0.80, e.g. between 0.50% and 0.65%;
a silicon content ranging from 1.0 weight percent to 2.0 weight percent, e.g. between 1.20% and 1.80%;
a manganese content ranging from 0.40 weight percent to 1.0 weight percent, e.g. between 0.45% and 0.90%;
a chromium content ranging from 0.0 weight percent to 1.0 weight percent, e.g. below 0.2% or between 0.40 and 0.90%;
a sulphur and phosphor content being limited to 0.025 weight percent,
the remainder being iron and unavoidable impurities.
   this steel wire has as metallurgical structure a volume percentage of retained austenite ranging from 4 percent to 20 percent, preferably between 6% and 20%, while the remainder is tempered primary martensite and untempered secondary martensite. In addition, the steel wire may comprise low amounts of alloying elements, such as nickel, vanadium, aluminium or other micro-alloying elements all being individually limited to 0.2 weight percent.

The volume percentage of retained austenite can be obtained by means of X-Ray Diffraction (XRD) analysis.

The tempered primary martensite is the result of the quenching step after austenitizing, the untempered secondary martensite is the result of cooling down to room temperature after partitioning.

The retained austenite increases the resistance to fracture and the damage tolerance in rolling or sliding contact fatigue. Due to a combination of martensite and carbon enriched retained austenite, both hardness and ductility are obtained and both hardness and good contact fatigue properties are obtained.

In the retained austenite there is more than 1 weight % of carbon.

According to a preferable embodiment of the invention, the steel wire is in an unworked state. The steel wire has a tensile strength Rₘ of at least the following values:
at least 1600 MPa, e.g. at least 1700 MPa for wire diameters above 5.0 mm;
at least 1700 MPa, e.g. at least 1800 MPa for wire diameters above 3.0 mm;
at least 1800 MPa, e.g. at least 2000 MPa for wire diameters above 0.5 mm.

The wires have an elongation at fracture Aₜ of at least 5%, e.g. at least 6%.

The steel wires preferably have a high combination tensile strength Rₘ and percentage elongation at fracture Aₜ characterized by the product Rₘ×Aₜ>15000.

For steel wires with a diameter ranging from 1.0 mm to 6.0 mm, these values are very high and the combination the level of tensile strength with the high level of elongation is uncommon.

The terms “the steel wire is in an unworked state” mean that after the partitioning and the cooling step, the steel wire is not work hardened by means of a mechanical transformation such as wire drawing or rolling.

Such a steel wire may have a yield strength R_{p0.2} which is at least 60 percent of the tensile strength Rₘ. R_{p0.2} is the yield strength at 0.2% permanent elongation.

According to another preferable embodiment of the invention, the steel wire is in a work-hardened state. The steel wire has a tensile strength of Rₘ at least 2200 MPa, e.g. at least 2400 MPa, and an elongation at fracture Aₜ of at least 3%.

The terms “the steel wire is in a work-hardened state” mean that after the partitioning and cooling step, the steel wire is further mechanically deformed, e.g. by drawing or by rolling. It is known as such that work-hardening increases the tensile strength Rₘ and decreases ductility parameters such as the elongation at fracture Aₜ. However, as will be illustrated hereinafter, in comparison with patented steel wires, only a few reductions steps suffice to reach comparative levels of tensile strength.

The tensile strength increase as a function of the logarithmic stress is very high in comparison to patented wire. While for prior art wires the strength increase during cold drawing is usually around 7 N/mm² for 1% section reduction, the invention wire showed a strength increase between 12 and 20 N/mm² for 1% section reduction.

This exceptional behavior is due to the fact that the steel wires exhibits a transformation induced plasticity during deformation.

Such a work-hardened steel wire in a cold-drawn state, i.e. after cold drawing, may have a yield strength R_{p0.2} which is at least 85% of the tensile strength Rₘ.

Such a work-hardened steel wire can also be cold rolled. The steel wire then has a flat or rectangular cross-section.

According to a second aspect of the invention, the high-carbon steel wire finds some applications or uses as spring wire, as wire in a steel or hybrid rope or as reinforcement of flexible pipes. This is particularly the case if the steel wire is work-hardened.

Another application, particularly if the steel wire is unworked, is its use in impact absorbing devices such as impact beams (e.g. bumpers), protective textiles, and guard rails.

According to a third aspect of the present invention, there is provided a process of manufacturing a high-carbon steel wire.

The steel wire has following steel composition:
a carbon content ranging from 0.40 weight percent to 0.85 weight percent, e.g. between 0.45% and 0.80, e.g. between 0.50% and 0.65%;
a silicon content ranging from 1.0 weight percent to 2.0 weight percent, e.g. between 1.20% and 1.80%;
a manganese content ranging from 0.40 weight percent to 1.0 weight percent, e.g. between 0.45% and 0.90%;
a chromium content ranging from 0.0 weight percent to 1.0 weight percent, e.g. below 0.2% or between 0.40 and 0.90%;
a sulphur and phosphor content being limited to 0.025 weight percent,
the remainder being iron and unavoidable impurities. In addition, the steel wire may comprise low amounts of alloying elements, such as nickel, vanadium, aluminium or other micro-alloying elements all being individually limited to 0.2 weight percent.

The process comprises the following steps:

a) austenitizing said steel wire above Ac₃ temperature during a period less than 120 seconds; this austenitizing can occur in a suitable furnace or oven, or can be reached by means of induction or a combination of a furnace and induction;

b) quenching said austenitized steel wire between 180° C. and 220° C. during a period less than 60 seconds; quenching can be done in an oil bath, a salt bath or in a polymer bath;

c) partitioning said quenched steel wire between 320° C. and 460° C. during a period ranging from 10 seconds to 600 seconds; partitioning can be done in a salt bath, in a bath of a suitable metal alloy with low melting point, in a suitable furnace or oven, or can be reached by means of induction or a combination of a furnace and induction.

After the quenching step b), which occurs between Mₛ, the temperature at which martensite formation starts and M_{f}, the temperature at which martensite formation is finished, retained austenite and martensite has been formed. During the partitioning step c), carbon diffuses from the martensite phase to the retaining austenite in order to stabilize it more.

The result is a carbon-enriched retained austenite and a tempered martensite.

After the partitioning step c), the partitioned steel wire is cooled down to room temperature. The cooling can be done in a water bath. This cooling down causes a secondary untempered martensite, next to the retained austenite and the primary tempered martensite.

Preferably, the austenitizing step a) occurs at temperatures ranging from 920° C. to 980° C., most preferably between 930° C. and 970° C. Preferably, the partitioning step c) occurs at relatively high temperatures ranging from 400° C. to 420° C., more preferably from 420° C. to 460° C. The inventor has experienced that these temperature ranges are favourable for the stability of the retaining austenite in the final high-carbon steel wire.

### BRIEF DESCRIPTION OF FIGURES IN THE DRAWINGS

FIG. 1 illustrates a temperature versus time curve for a process according to the invention;

FIG. 2 and FIG. 3 illustrate the optimum temperature ranges for a stable retaining austenite;

FIG. 4 compares the strain hardening curves of various prior art patented steel wires with invention steel wires.

FIG. 5 shows the increase in tensile strength as a function of the percentage of section reduction by cold drawing for patented steel wire and invention steel wires.

### MODE(S) FOR CARRYING OUT THE INVENTION

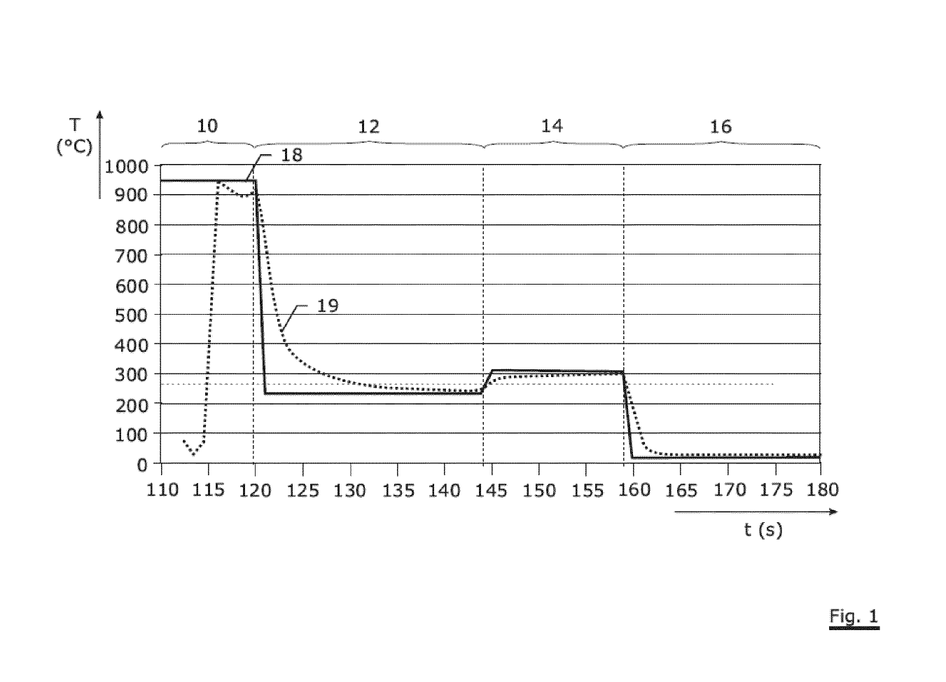

FIG. 1 illustrates a suitable temperature versus time curve applied to a drawn steel wire with a diameter of 3.60 mm and with following steel composition:
% C=0.55
% Si=1.62
% Mn=0.70
% Cr=0.77
   the balance being iron and unavoidable impurities (% S and % P below 0.020 and weight percentages of other elements below 0.10)

The starting temperature of martensite transformation Mₛ of this steel is about 280° C. and the temperature M_{f}, at which martensite formation ends is about 170° C.

The various steps of the process are as follows:
a first austenitizing step (10) during which the steel wire stays in a furnace at about 950° C. during 120 seconds,
a second quenching step (12) for partial martensite transformation at a temperature below 280° C. during less than 25 seconds;
a third partitioning step (14) for moving carbon atoms from the martensite phase to the austenite phase to stabilize this at a temperature above 300° C. during about 15 seconds; and
a fourth cooling step (16) at room temperature during 20 or more seconds.

Curve 18 is the temperature curve in the various equipment parts (furnace, bath . . . ) and curve 19 is the temperature of the steel wire.

Test Set-Up

Three steel wires with different diameters, namely one steel wire with a diameter of 6.0 mm, one steel wire with a diameter of 3.6 mm and one steel wire with a diameter of 1.2 mm, have been processed according to six different processes according to the invention.

These different processes all had 950° C. as austenitizing temperature Tₐᵤₛₜ and 200° C. as quenching temperature T_{quench} but had varying temperatures of partitioning Tₚₐᵣₜ:

a) 450° C.,

b) 425° C.,

c) 400° C.,

d) 375° C.,

e) 350° C. and

f) 325° C.

Following parameters have been measured:
tensile strength Rₘ
percentage total elongation at fracture Aₜ
permanent elongation at maximum load A_{g}
yield strength at 0.2% permanent elongation R_{p0.2}
the ratio of yield strength R_{p0.2} to tensile strength Rₘ
modulus of elasticity E
percentage reduction of area Z
number of torsions or twists Nₜ
percentage of retaining austenite γ.

The work has been calculated and is characterized by the product Rₘ×Aₜ.

This gives us the results in Tables 1, 2 and 3.

The thus obtained wires of 6.0 mm, 3.6 mm and 1.2 mm have then been subjected to an artificial ageing treatment of 15 minutes at 200° C. This gives the results of Tables 4, 5 and 6.

TABLE 1
Wire diameter = 6.0 mm

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1635 | 14.1 | 23054 | 10.6 | 1348 | 82.4 | 199459 | 50 | 11.7 | 17.27 |
| b) 425 | 1681 | 11.9 | 20004 | 8.74 | 1410 | 83.9 | 192638 | 54 | 9.67 | 14.93 |
| c) 400 | 1736 | 12.5 | 21700 | 8.66 | 1386 | 79.8 | 201794 | 52 | 9.00 | 12.81 |
| d) 375 | 1854 | 12.5 | 23175 | 8.90 | 1299 | 70.1 | 200524 | 43 | 8.67 | 11.57 |
| e) 350 | 2025 | 6.48 | 13122 | 5.47 | 1249 | 61.7 | 200001 | 9.4 | 7.33 | 12.96 |
| f) 325 | 2200 | 4.85 | 10670 | 3.72 | 1356 | 61.7 | 194543 | 7.0 | 6.00 | 8.69 |

TABLE 2
Wire diameter = 3.6 mm

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1732 | 12.6 | 21823 | 9.85 | 1446 | 83.5 | 201995 | 52 | 19.0 | 13.54 |
| b) 425 | 1763 | 10.4 | 18335 | 7.93 | 1471 | 83.4 | 204317 | 55 | 19.0 | 15.14 |
| c) 400 | 1803 | 10.1 | 18210 | 8.00 | 1414 | 78.4 | 202709 | 45 | 19.0 | 14.19 |
| d) 375 | 1931 | 9.91 | 19136 | 8.31 | 1312 | 68.0 | 202714 | 25 | 16.0 | 12.14 |
| e) 350 | 1949 | 3.89 | 7582 | 2.92 | 1234 | 63.3 | 202222 | 9.2 | 16.0 | 11.98 |
| f) 325 | 1945 | 2.40 | 4668 | 1.40 | 1355 | 69.8 | 196394 | 5.9 | 12.0 | 9.51 |

TABLE 3
Wire diameter = 1.2 mm

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1880 | 12.6 | 23688 | 10.2 | 1576 | 83.8 | 185514 | 60 | 21.3 | 6.55 |
| b) 425 | 1943 | 12.0 | 23316 | 10.2 | 1568 | 80.7 | 186142 | 61 | 19.3 | 6.19 |
| c) 400 | 2058 | 10.7 | 22021 | 8.90 | 1553 | 75.5 | 185042 | 59 | 18.0 | 7.38 |
| d) 375 | 2164 | 11.1 | 24020 | 9.11 | 1398 | 64.6 | 191584 | 57 | 17.7 | 6.41 |
| e) 350 | 2285 | 10.1 | 23079 | 8.08 | 1401 | 61.3 | 191327 | 53 | 15.0 | 7.52 |
| f) 325 | 2388 | 9.17 | 21898 | 7.37 | 1469 | 61.5 | 192715 | 51 | 14.3 | 4.99 |

TABLE 4
Wire diameter = 6.0 mm-after artificial ageing

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1639 | 14.2 | 23274 | 11.3 | 1366 | 83.3 | 204536 | 52 | 10.7 | 15.85 |
| b) 425 | 1682 | 8.13 | 13675 | 6.84 | 1434 | 85.2 | 202734 | 52 | 10.0 | 13.20 |
| c) 400 | 1733 | 9.49 | 16446 | 7.38 | 1408 | 81.2 | 209541 | 53 | 9.33 | 11.26 |
| d) 375 | 1861 | 11.7 | 21774 | 8.73 | 1357 | 72.9 | 196204 | 42 | 9.00 | 18.12 |
| e) 350 | 2046 | 11.6 | 23734 | 8.62 | 1330 | 65.0 | 200434 | 24 | 7.67 | 9.00 |
| f) 325 | 2242 | 6.69 | 14999 | 5.56 | 1467 | 65.4 | 198020 | 8.0 | 6.00 | 9.01 |

TABLE 5
Wire diameter = 3.6 mm - after artificial ageing

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1724 | 13.0 | 22412 | 10.0 | 1439 | 83.4 | 203748 | 53 | 20.3 | 14.13 |
| b) 425 | 1757 | 10.8 | 18976 | 8.14 | 1477 | 84.1 | 197721 | 54 | 18.3 | 13.28 |
| c) 400 | 1797 | 11.4 | 20486 | 8.73 | 1414 | 78.7 | 202216 | 49 | 18.0 | 12.46 |
| d) 375 | 1911 | 7.82 | 14944 | 6.34 | 1355 | 70.9 | 203572 | 24 | 17.3 | 11.17 |
| e) 350 | 1953 | 3.91 | 7636 | 2.94 | 1318 | 67.5 | 201791 | 8.4 | 15.0 | 10.90 |
| f) 325 | 2011 | 2.46 | 4947 | 1.47 | 1531 | 76.1 | 203634 | 6.0 | 11.7 | 9.80 |

TABLE 6
Wire diameter = 1.2 mm after artificial ageing

| Tₚₐᵣₜ | Rₘ | Aₜ | RₘxAₜ | Ag | R_{p0.2} | R_{p0.2}/Rₘ | E | Z | | Y |
|---|---|---|---|---|---|---|---|---|---|---|
| (° C.) | (MPa) | (%) | (MPa. %) | (%) | MPa | (%) | (MPa) | (%) | Nₜ | (%) |
| a) 450 | 1882 | 11.1 | 20890 | 9.44 | 1608 | 85.4 | 198837 | 64 | 20.7 | 5.50 |
| b) 425 | 1941 | 9.59 | 18614 | 7.54 | 1602 | 82.5 | 204445 | 61 | 19.3 | 6.52 |
| c) 400 | 2048 | 10.1 | 20685 | 8.19 | 1579 | 77.1 | 202649 | 61 | 18.7 | 6.09 |
| d) 375 | 2157 | 9.19 | 19823 | 7.75 | 1470 | 68.2 | 203952 | 58 | 17.7 | 6.07 |
| e) 350 | 2278 | 9.54 | 21732 | 7.66 | 1544 | 67.8 | 201285 | 55 | 15.3 | 6.12 |
| f) 325 | 2365 | 8.57 | 20268 | 6.66 | 1613 | 68.2 | 199482 | 53 | 13.7 | 2.52 |

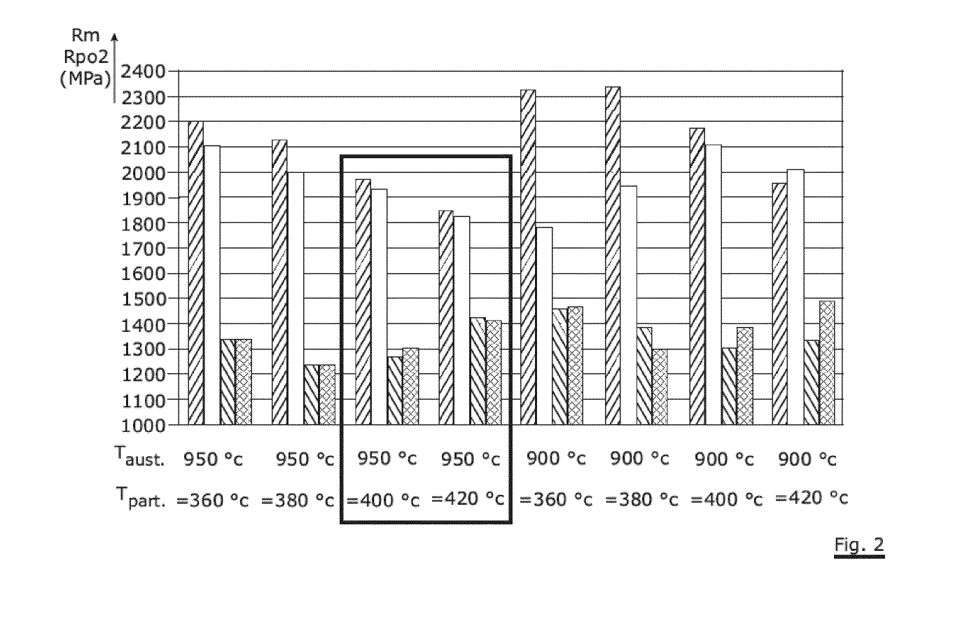

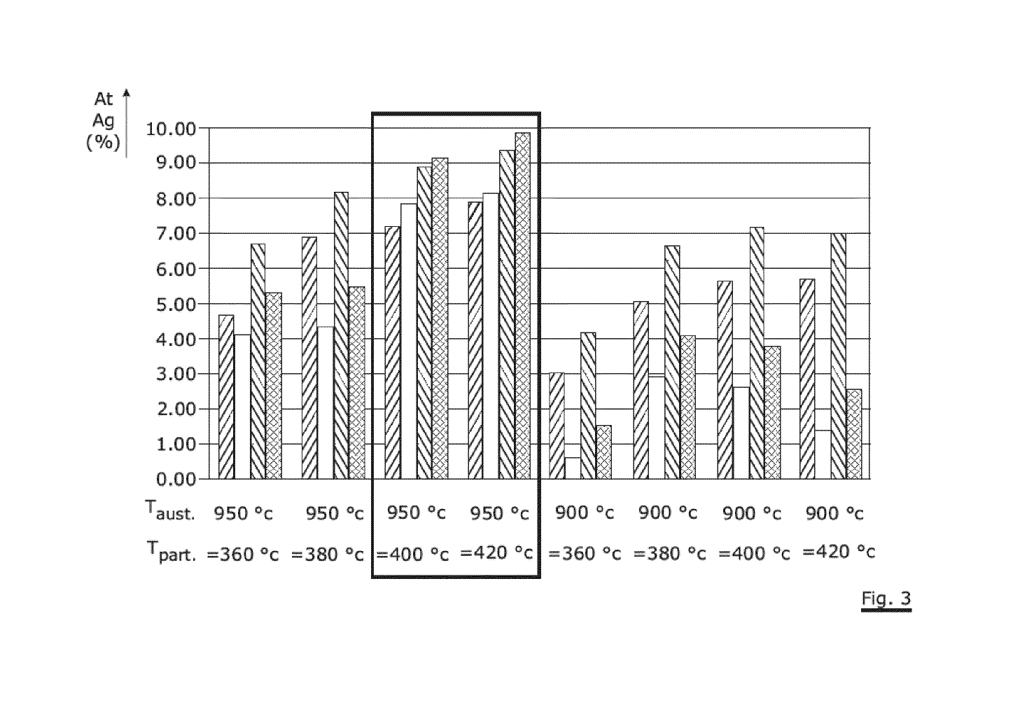

Austenite is known as an unstable phase. The purpose of the partitioning step is to have carbon atoms migrated from martensite to austenite in order to stabilize the austenite phase. FIG. 2 and FIG. 3 illustrate the stability of the austenite phase in the high-carbon steel wire.

Both FIG. 2 and FIG. 3 have as abscissa combinations of the values of the austenitizing temperature Tₐᵤₛₜ and of the partitioning temperature Tₚₐᵣₜ.

FIG. 2 has as ordinate the tensile strength Rₘ and the yield strength R_{p0.2}.

In FIG. 2 there are four columns for each combination of Tₐᵤₛₜ and Tₚₐᵣₜ.

The first column (hatched from below to above) is the value of the tensile strength Rₘ of a high-carbon steel wire as measured in April 2010.

The second column (blanc) is the value of the tensile strength Rₘ of the same high-carbon steel wire as measured in September 2010.

The third column (hatched from above to below) is the value of the yield strength R_{N 2} of the high-carbon steel wire as measured in April 2010.

The fourth column (cross-hatched) is the value of the yield strength R_{p0.2} of the same high-carbon steel wire as measured in September 2010.

FIG. 3 has as ordinate the percentage total elongation at fracture Aₜ, and the permanent elongation at maximum load A_{g}.

In FIG. 3 there are four columns for each combination of Tₐᵤₛₜ and Tₚₐᵣₜ.

The first column (hatched from below to above) is the percentage total elongation at fracture Aₜ of a high-carbon steel wire as measured in April 2010, the second column (blanc) is the percentage total elongation at fracture Aₜ of the same high-carbon steel wire as measured in September 2010.

The third column (hatched from above to below) is the value of the permanent elongation at maximum load A_{g} of the high-carbon steel wire as measured in April 2010, the fourth column (cross-hatched) is the permanent elongation at maximum load A_{g} of the same high-carbon steel wire as measured in September 2010.

Those combinations and situations where a high level of stability of the various values was noticed is put in a rectangle. A high austenitizing temperature Tₐᵤₛₜ of about 950° C., combined with relatively high temperatures of partitioning Tₚₐᵣₜ of about 400° C. to 420° C. are the best combinations to preserve in time the values of tensile strength Rm and of elongation Aₜ and A_{g}. These higher temperatures stimulate the dissolution of carbon into the austenite phase.

### Effect of Work Hardening

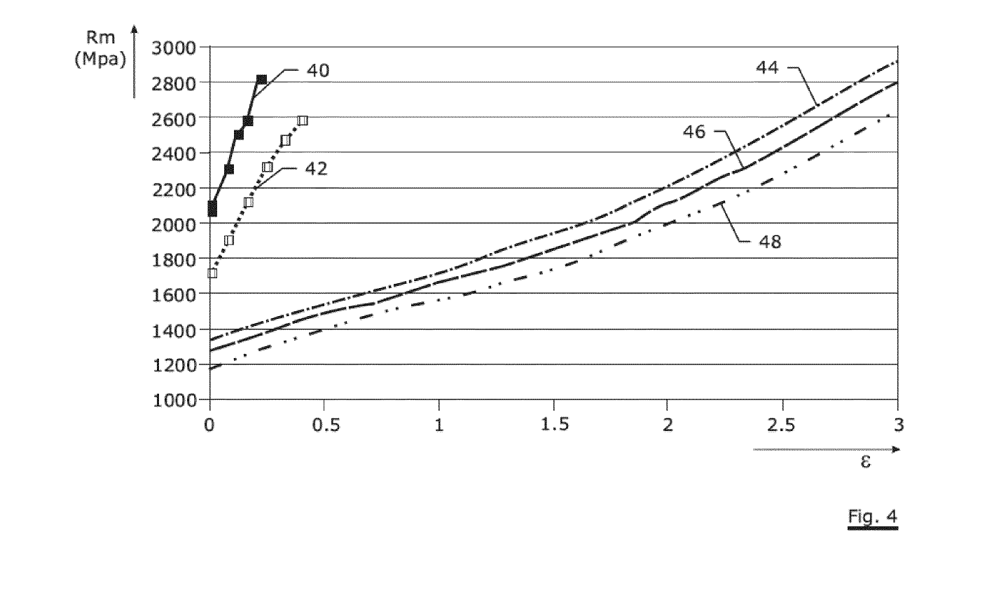

FIG. 4 shows the effect of further drawing of steel wires according to the invention and makes a comparison with the strain hardening of prior art patented steel wires. Abscissa is the logarithmic strain c and ordinate is the tensile strength Rₘ.

Curve 40 is the strain hardening curve of an invention high-carbon steel wire (0.55% C, 0.70% Mn, 1.62% Si and 0.77% Cr) which was partitioned at Tₚₐᵣₜ equal to 325° C. Diameter is 3.6 mm

Curve 42 is the strain hardening curve of an invention high-carbon steel wire (0.55% C, 0.70% Mn, 1.62% Si and 0.77% Cr) which was partitioned at Tₚₐᵣₜ equal to 450° C. Diameter is 3.6 mm.

Each dot represents a reduction step.

Curves 44, 46 and 48 are strain hardening curves of patented steel wires with a plain carbon composition (=only traces of alloying elements).

Curve 44 is for a steel wire with 0.90% C, Curve 46 for a steel wire with 0.80% C and curve 48 for a steel wire with 0.70% C.

Both types of wires, the quenched and partitioned steel wires according to the invention and the patented steel wires according to the prior art, can be strain hardened, i.e. drawn, until high tensile strengths above 2500 MPa. However, it is remarkable that for the partitioned and quenched steel wires according to the invention, only a very limited number of cross-section reductions is needed.

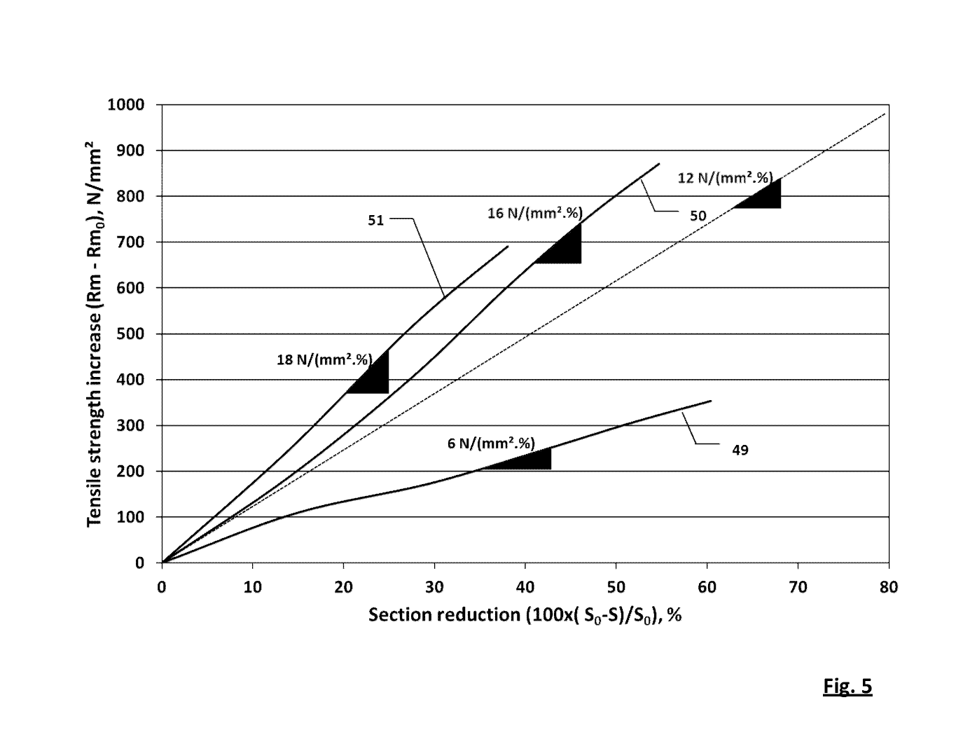

In FIG. 5, abscissa is the percentage of the section reduction and ordinate is the tensile strength increase due to the cold deformation. The percentage of section reduction is calculated by means of the formula: 100×(S₀−S)/S₀, wherein S₀ is the section area before deformation and S is the section area after reduction. The tensile strength increase is defined as Rm−Rm₀, wherein Rm is the tensile strength after cold deformation and Rm₀ is the original tensile strength before deformation. As illustrated in FIG. 5, curve 49 is the hardening curve of a prior art patented wire and curves 50 and 51 are for invention wires partitioned at 450° C. and 350° C., respectively. While the increase of tensile strength for prior art wire is 6 to 8 N/mm² for 1% section reduction, tensile strength increase between 12 and 20 N/mm² per 1% section reduction are measured during drawing the invention wires when the section reduction is below 50%. The tensile strength increase during cold deformation of the invention wire is very high in comparison to the patented prior art wire. This exceptional behaviour due to transformation induced plasticity is associated with a decrease of the retained austenite during deformation. In the case of curve 51, the retained austenite measured by XRD decreased linearly from 16 vol % before deformation to 0 when the section reduction reached 40%.

1-15. (canceled)

16. A high-carbon steel wire having as steel composition:
a carbon content ranging from 0.40 weight percent to 0.85 weight percent,
a silicon content ranging from 1.0 weight percent to 2.0 weight percent,
a manganese content ranging from 0.40 weight percent to 1.0 weight percent,
a chromium content ranging from 0.0 weight percent to 1.0 weight percent,
a sulphur and phosphor content being limited to 0.025 weight percent,
the remainder being iron,
said steel wire having as metallurgical structure:
a volume percentage of retained austenite ranging from 4 percent to 20 percent, the remainder being tempered primary martensite and untempered secondary martensite.

17. A steel wire according to claim 16,
said steel wire being in an unworked state,
said steel wire having a tensile strength Rₘ of at least 1600 MPa for wire diameters above 5.0 mm and at least 1700 MPa for wire diameters above 3.0 mm and at least 1800 MPa for wire diameters above 0.50 mm,
said steel wire having an elongation at fracture Aₜ of at least 5 percent.

18. A steel wire according to claims 16,
said steel having a high combination of tensile strength Rₘ and elongation at fracture Aₜ characterized by the product Rₘ×Aₜ>15000.

19. A steel wire according to claim 17,
said steel wire having a yield strength R_{p0.2} which is at least 60 percent of the tensile strength Rₘ.

20. A steel wire according to claim 16,
said steel wire being in a work-hardened state,
said steel wire having a tensile strength Rₘ of at least 2200 MPa,
said steel wire having an elongation at fracture Aₜ of at least 3 percent.

21. A steel wire according to claims 16, said steel wire having a transformation induced plasticity behaviour during deformation, characterized by the fact that the tensile strength increase during cold deformation is at least 12 N/mm² for 1% section reduction when the section reduction is below 50%.

22. A steel wire according to claim 20,
said steel wire being in a cold-drawn state,
said steel wire having a yield strength R_{p0.2} which is at least 85 percent of the tensile strength Rₘ.

23. A steel wire according to claim 20,
said steel wire being in a cold-rolled state and having a non-round cross-section.

24. Use of a steel wire according to claim 16 as a spring wire.

25. A rope comprising one or more steel wires according to claim 16.

26. A flexible pipe comprising one or more steel wires according to claim 23.

27. Use of a steel wire according to claim 17 for absorbing impacts.

28. A process of manufacturing a high-carbon steel wire,
said steel wire having as steel composition:
a carbon content ranging from 0.40 weight percent to 0.85 weight percent,
a silicon content ranging from 1.0 weight percent to 2.0 weight percent,
a manganese content ranging from 0.40 weight percent to 1.0 weight percent,
a chromium content ranging from 0.0 weight percent to 1.0 weight percent,
a sulphur and phosphor content being limited to 0.025 weight percent, the remainder being iron,
said process comprising the following steps:
a) austenitizing said steel wire above Ac3 temperature during a period less than 120 seconds,
b) quenching said austenitized steel wire between 180° C. and 220° C. during a period less than 60 seconds,
c) partitioning said quenched steel wire between 320° C. and 460° C. during a period ranging from 10 seconds to 600 seconds.

29. A process according to claim 28,
said process further comprising the step of:
d) cooling down the partitioned steel wire to room temperature.

30. A process according to claim 28,
wherein said austenitizing occurs at a temperature between 920° C. and 980° C.
